(19) United States
(12) Patent Application Publication
(10) Pub. No.: US 2011/0202686 A1
(43) Pub. Date: Aug. 18, 2011

(54) Network Based Conversion System

(76) Inventor: Michael E. Gallina, Astoria, NY (US)

(21) Appl. No.: 12/707,261

(22) Filed: Feb. 17, 2010

(51) Int. Cl. G06F 15/16

(52) U.S. Cl. 709/246

(57) ABSTRACT

The invention is a network-based personalized media conversion system, process, and method for receiving original media data from a client-end device connected to a network, transmitting back converted digital data from a server-end device to the client-end external device, and manipulating the converted data through a client-end editing and a server-end editing interface. The transmitted signal is reproduced into a digital format that may or may not have additional meta-data appended to it based on use of the editing interface. A server-end payment transaction system, used to monitor a client's session, communicates with a server-end dispatcher that transmits compressed and converted data back to the client-end device. A server-end archive stores client reproductions during the client's session with the conversion system, and for a designated time interval after a client's session has ended.

### BACKGROUND OF INVENTION

1. Field of Invention

Said invention provides a means of archiving, digitally reproducing and improving video and audio data. The method employed by the invention enables a process by which video and audio data can be stored in large capacity. In this regard said invention applies directly to the field of digital reproduction, media archiving and cultural preservation. While this process provides a means to archive data it also enables altering and potentially improving the quality of the original signal being reproduced. In addition to media archiving and cultural preservation said invention is also applicable to the field of digital enhancement.

2. Prior Art

A commonly used device which achieves a similar end product is a digital audio conversion system made by DAK industries. In regards to usability the device's design is similar to a standard turntable mixer with the added feature of digital output that can be ported to a computer's USB input. The reproducing device has an input which connects to a media transmitting device such as a cassette deck or turntable while the DAK device's output is connected to a computer. DAK industries software interprets the audio signal from the DAK reproducing device which is installed on the receiving computer. As a record or tape cassette is played, it is transferred to the computer and converted to a digitized reproduction.

While this device enables archiving and digitally reproducing data transmitted from an older medium such as vinyl or cassette tape, the majority of other related prior art devices and conversion methods available are not designed to convert an outdated format (such as analog signal) to a digital format. Most are used to convert from one digital format to another to be played on different devices because most devices (such as the iPod) and programs (such as Windows Media Player) will only play a few specific formats.

### RESEARCH

Databases searched: USPTO, WIPO.

Query used: audio video format conversion.

Database searched: by Google.

Query used: server client audio video format conversion.
a website mentioned “free online video and audio conversion” but lack of any detail. (http://www.ghacks.net/2007/06/09/free-online-audio-and-video-converter/)

Query used: online server client audio video format conversion.
no network based media conversion program was found.

Database searched: USPTO

Query used online and server and client and audio and video and format and conversion
no relevant pending or issued patent found.

### PRIOR ART FAILURES

From a usability standpoint, previous methods and devices add a layer of complexity for users who are not familiar with audio mixing and audio recording technology. In the case of DAK industry's conversion device, it employs a process which requires reproducing obsolete technologies such as a turntable mixer in order to achieve the digital reproduction. Other solutions and methods require the user to install software on the user's personal computer. In addition prior art does not explicitly employ any means of adding meta-data such as an artist's name or a track title in the case of a music to the digital reproduction produced.

### IMPROVEMENT OVER PRIOR ART

The novelty of the invention is that it claims a process where a user can access and manipulate the media-format-conversion program on a server through the interne, either wireless or cable. An audio/video format conversion program/software by itself is not new. There are various audio format conversion program/software available. However, users need to download those program/software to their own computers and can only run the program/software on their computer.

### SUMMARY OF INVENTION

The invention is a network-based personalized media conversion system, process, and method for receiving an original media data from a client-end external device connected to a network and distributing the converted digital data to the client-end external device. The invention comprises: a client-end external device that transmits an original media data recorded on a digital or non-digital medium to the network; a server-end receiver that receives a media data from the client-end external device connected to the network; a control interface that a client executes a data format conversion request from the client-end external device; a transmitter that transmits the converted media data to the client-end external device during the recording and conversion process; a client-end receiver that receives the partially or completely converted media data from the server connected to the network; a server-end editing interface that the user monitors and edits converted media data from the client-end external device during the recording and conversion process; a server-end payment interface that determines and charges a fee to an account of the user; a server-end compressing apparatus compresses the digital media data upon session termination; a server-end dispatcher sends the compressed media file to the client-end external device; and a server-end archive stores client reproductions while a client is interacting with the conversion system and for a designated time interval after a client's session has ended

The client-end external device transmits an original media data recorded on a digital or non-digital medium to the network. The client-end external device may include a computer, a medium playing device, an apparatus connecting the computer and the non-digital medium playing device, and an apparatus connecting the computer to the network. Said medium playing device may include various analog and digital media playing devices such as a cd players, cassette players, record players, VCR, DVD players, or mp3 players, which transmit an audio, video, or combined audio video signal through an apparatus, such as a connector or a chord connected to the client-end receiver of the computer.

The server-end receiver receives, interprets, and converts an incoming media signal from the client-end external device to a temporary digital reproduction. The server-end receiver responds to the signal based on audio signal level, diversity or monotony of audio signal, and the diversity or monotony of an incoming video signal. As the server-end receiver interprets said signal it subsequently analyzes and reports to the control interface the state of the signal as unchanging, silent or functional. In addition to interpreting and reporting signal features the server-end receiver reacts to signal changes based on preset client settings determined by the client through interaction with the control interface prior to transmission from the client-end external device. The server-end receiver can be set to report all intervals of silence, ignore silence or report based on a specific time interval.

The control interface provides the clients with controls to monitor their session and dictate how the conversion system should behave based on criteria relating to the transmitted signal. From the control interface the client can specify a designated time interval the receiver should observe; the client can change settings in regards to whether or not the receiver observes audio signal monotony or silence and whether or not the receiver observes video signal monotony. The client can also manipulate previously recorded reproductions to either remove or playback said reproductions temporarily stored in the server-end archive. While the transmitted signal is processed or the client engages with the control interface, the control interface reflects the state of the receiver visually through changes in the user interface's graphical composition as well as with text based alerts. The states of the control interface may include options like recording, stop, processing, sending, transmitting, editing, waiting for client confirmation or feedback and idle.

The transmitter locates a previously converted reproduction temporarily stored in the server-end archive when notified based on the client's selection and plays back said reproduction with visual representation shown in the control interface's playback controls. The transmitter is activated based on client interaction with the control interface. The transmitter transmits the converted media data to the client-end external device during the recording and conversion process.

The client-end receiver interprets the signal coming from the transmitter which is subsequently broadcast to the server-end receiver. The client-end receiver is determined by the particulars of each client's receiving device. If the receiving device is a computer, the client-end receiver may be a computer microphone input, firewire port, usb port. In addition to serving as a receiving device for an incoming signal transmitted by the client-end external device, the client-end receiver also receives incoming data containing the client's compressed reproductions upon session termination.

The server-end editing interface provides controls for the client which allows further manipulation of how the signal is reproduced. The server-end editing interface allows the user to monitor and edits media data from the client-end external device during the recording and conversion process. With the server-end editing interface, the client can “cut” a reproduction into further divisions creating new files stored in the archive, the client can further by removing what may be considered white noise to audio signals. In addition, the server-end editing interface allows the client to analyze an audio signal for potentially unwanted parts of the audio signal's wave such as “pop” or “clicks” and remove or normalize those aspects of the signal

The server-end payment interface compares the amount of signal reproduced to a preset amount of reproductions allotted to the client based on payment terms. The server-end payment interface determines and charges a fee to an account of the user. As reproductions are created, the server-end payment interface tracks the amount of reproductions stored in the archive during a client's session interacting with the conversion system. Once the number of reproductions reaches said amount the server-end control interface alerts the client and temporarily stops the session. If the client chooses to interact with the conversion system without a reproduction limit the server-end payment system counts the amount of reproductions and determines a cost per reproduction when the client decides to terminate the session. If either the client terminates the session, chooses to make a payment or if a preset amount of reproductions is reached the server-end payment interface prompts the client to accept terms. If the client accepts terms, the client is directed to proceed with payment. If the client declines, the session is ended. Upon making payment details pertaining to the client's session, such as amount of reproductions times, reproduction file names and archive locations are recorded in a log stored in the archive.

The server-end compressing apparatus compresses the total amount of client reproductions created in the archive upon session termination. The server-end compressing apparatus has three stages of operation. In the initial stage incoming signal data is reproduced and stored as a temporary .flv file. Based either on settings chosen by the client in the sever-end control interface or on the detection of too low signal strength, monotonous/unchanging signal or signal artifacting the server-end compressing apparatus will continue to process the temporary .flv file converting and compressing the reproduction into either an .mp3, .m4a, .mov, .mpeg, .wav or an .avi file based on the client's choices in the control interface. Upon session termination the server-end compressing apparatus further compresses the total amount of client reproductions created in the archive for the terminated into a .zip archive file or its equivalent.

The server-end dispatcher locates a final compressed file or its equivalent of client reproductions created during a session interacting with the conversion system after notification from the server-end compressing apparatus upon session termination. Once notified from the server-end compressing apparatus upon session termination, the server-end dispatcher initiates a transfer of data from the server-end archive to the client-end receiver. In the event that a connection problem may occur, the server-end dispatcher dispatches an email containing an HTML hyperlink to the client's archived .zip file containing the client's reproductions stored during the current session.

The server-end archive stores client reproductions while a client is interacting with the conversion system and for a designated time interval after a client's session has ended. The server-end archive logs information relating to each client's session. The sever-end archive maintains reproductions and is also responsible for removing stored reproductions after a designated time interval has passed.

### DRAWING REFERENCES

FIG. 3: Illustrates the first step in the process which involves inserting a chord or a wireless transmitter into the output of an audio or video transmitting device.

FIG. 6: Illustrates the insertion of the same chord or a wireless transmitter shown in FIG. 3. In FIG. 6 the opposite end of the chord or the audio receiver connected to the audio or microphone input of an internet capable computer.

FIG. 9: The user begins the the audio/video transmitting device in play mode so the device begins transmitting a signal.

FIG. 12: Using any internet browsing software the user connects to the server application's url.

FIG. 15: The transmitted signal is received by the server application.

FIG. 18: The transmitted signal is converted based on the clients choices.

FIG. 21: The digital reproduction is sent back to the clients computer either as a signal or a compressed file.

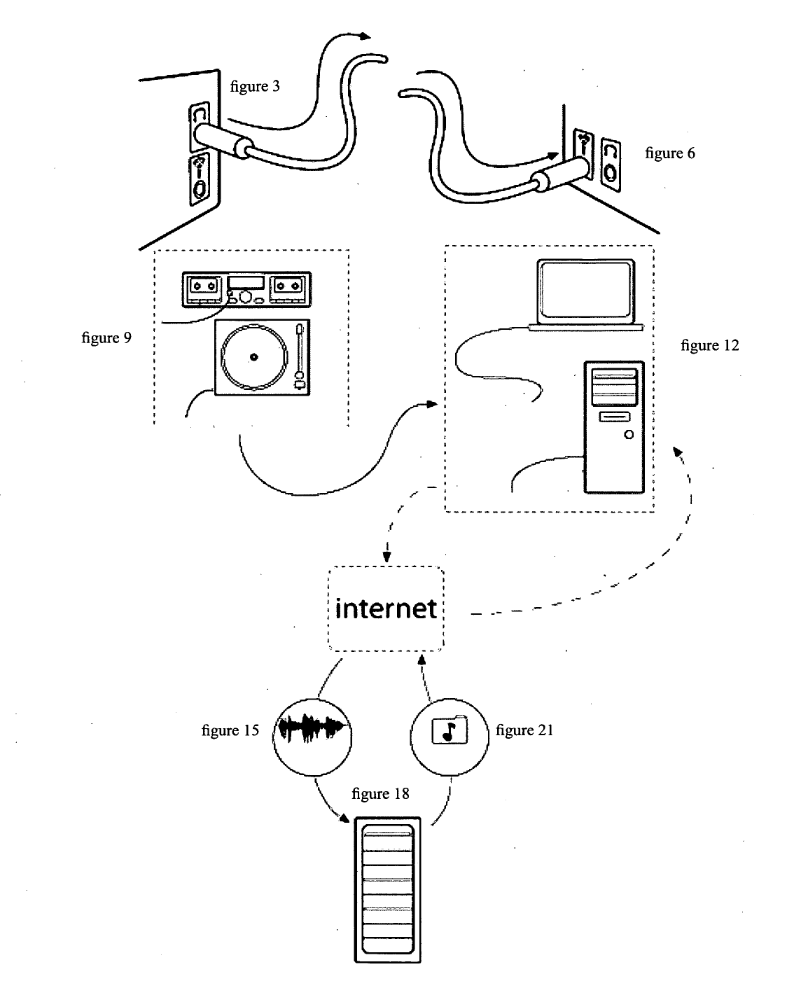

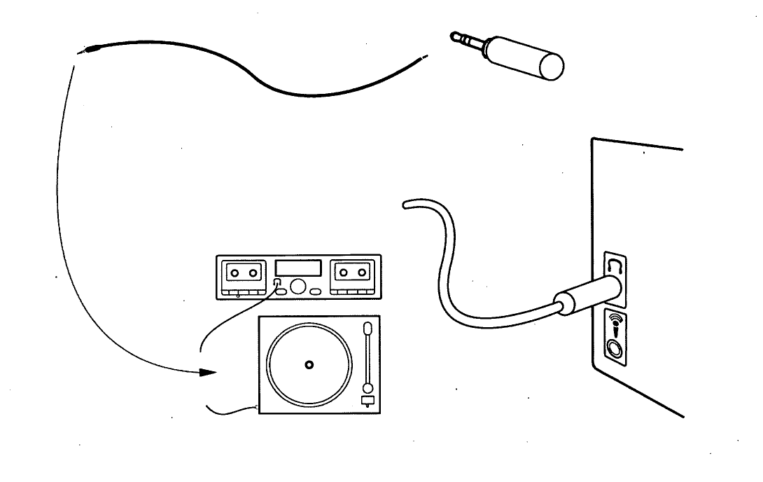

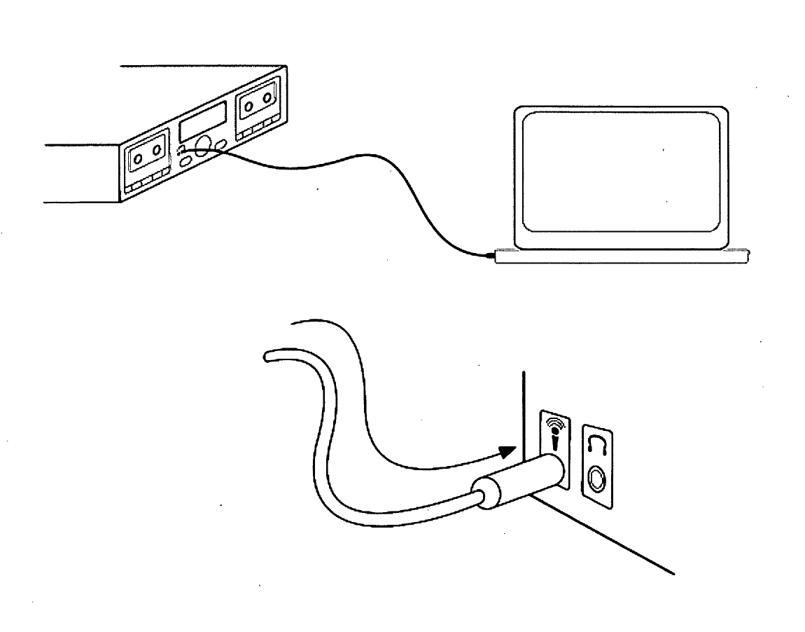

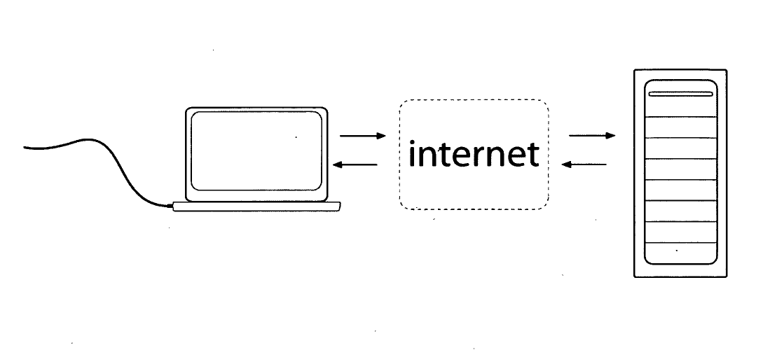

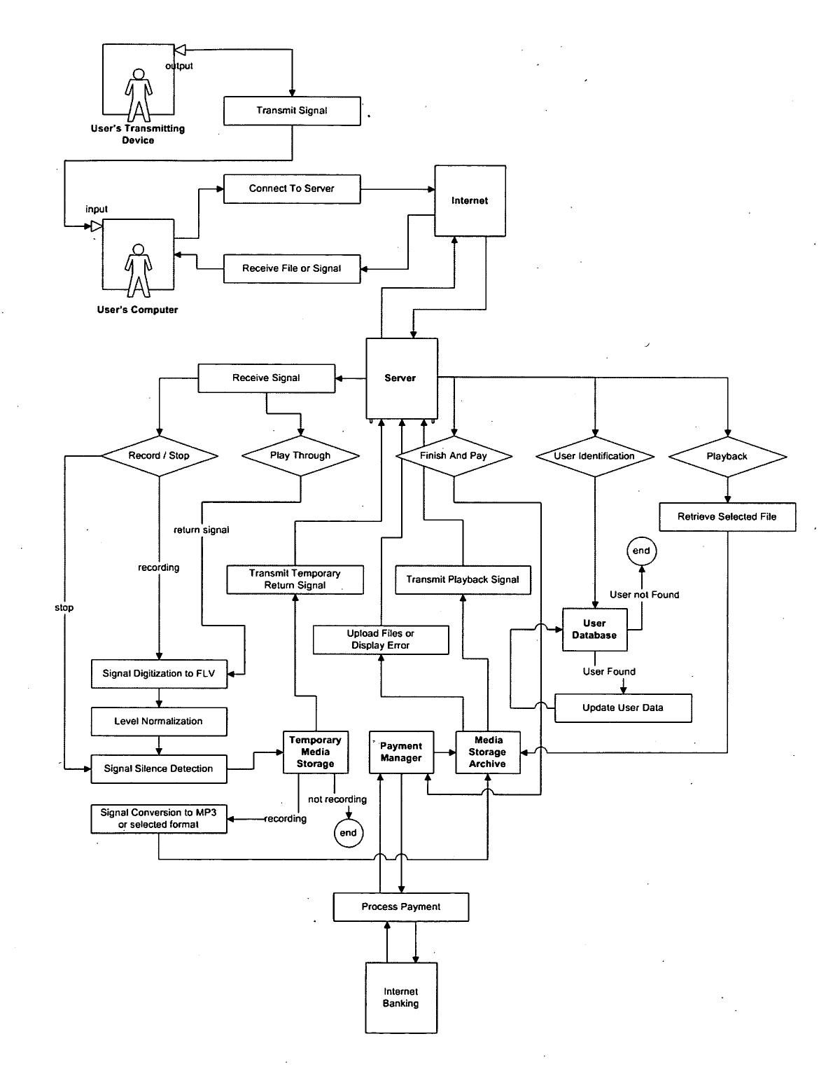

1. A network-based personalized media conversion system for receiving an original media data from a client-end external device connected to a network and distributing the converted digital data to the client-end external device, comprising: a client-end external device; a server-end receiver; a control interface; a transmitter; a client-end receiver; a server-end editing interface; a server-end payment interface; a server-end compressing apparatus; a server-end dispatcher; and a server-end archive.

2. A network-based personalized media conversion system according to claim 1, wherein said client-end external device transmits an original media data recorded on a digital or non-digital medium to the network.

3. A network-based personalized media conversion system according to claim 1, wherein said server-end receiver receives, interprets, and converts an incoming media signal from the client-end external device to a temporary digital reproduction.

4. A network-based personalized media conversion system according to claim 1, wherein said control interface provides the clients with controls to monitor their session and dictate how the conversion system should behave based on criteria relating to the transmitted signal.

5. A network-based personalized media conversion system according to claim 1, wherein said transmitter locates a previously converted reproduction temporarily stored in the server-end archive when notified based on the client's selection and plays back said reproduction with visual representation shown in the control interface's playback controls.

6. A network-based personalized media conversion system according to claim 1, wherein said client-end receiver interprets the signal coming from the transmitter which is subsequently broadcast to the server-end receiver.

7. A network-based personalized media conversion system according to claim 1, wherein said server-end editing interface provides controls for the client which allows further manipulation of how the signal is reproduced.

8. A network-based personalized media conversion system according to claim 1, wherein said server-end payment interface compares the amount of signal reproduced to a preset amount of reproductions allotted to the client based on payment terms.

9. A network-based personalized media conversion system according to claim 1, wherein said server-end compressing apparatus compresses the total amount of client reproductions created in the archive upon session termination.

10. A network-based personalized media conversion system according to claim 1, wherein said server-end dispatcher locates a final compressed file or its equivalent of client reproductions created during a session interacting with the conversion system after notification from the server-end compressing apparatus upon session termination.

11. A network-based personalized media conversion system according to claim 1, wherein said server-end archive stores client reproductions while a client is interacting with the conversion system and for a designated time interval after a client's session has ended.
